(19) United States
(12) Patent Application Publication
(10) Pub. No.: US 2024/0118659 A1
(43) Pub. Date: Apr. 11, 2024

(54) HOLOGRAM PROJECTION APPARATUS AND METHOD

(71) Applicant: KIEL INSTITUTE, Bucheon-si (KR)

(72) Inventors: Hong-Shik LEE, Seoul (KR); Jae Hyoung RYU, Iksan-si (KR); Sol Ah JEON, Jeonju-si (KR)

(73) Assignee: KIEL INSTITUTE, Bucheon-si (KR)

(21) Appl. No.: 18/233,286

(22) Filed: Aug. 11, 2023

Related U.S. Application Data
(63) Continuation of application No. PCT/KR2022/016395, filed on Oct. 26, 2022.

(30) Foreign Application Priority Data
Oct. 5, 2022 (KR) 10-2022-0127352

(51) Int. Cl. G03H 1/00; G03B 21/14; G03B 21/20

(52) U.S. Cl. CPC G03H 1/0005; G03B 21/142; G03B 21/2013; G03H 2001/0033

(57) ABSTRACT

A hologram projection apparatus according to an embodiment of the present invention includes: a hologram image projector configured to project a hologram test image for testing a hologram image onto a projection plate through a plurality of projection modules projecting R, G, and B images, respectively; an optimal angle calculation configured to calculate optimal projection angles of each of the projection modules when quality of the hologram test image does not satisfy reference quality; and a projection module adjuster configured to adjust angles of each of the projection modules to the optimal projection angles.

### TECHNICAL FIELD

Embodiments of the present invention relate to a hologram projection apparatus and method, and more particularly, to a hologram projection apparatus and method capable of preventing deterioration in quality of a hologram image.

### BACKGROUND ART

Recently, with the development of technologies for providing 3D stereoscopic images, products or services providing various types of immersive images, such as 3D TVs and hologram performances, are appearing. An electronic method, such as a 3D TV, provides images in consideration of a visual difference between left and right eyes viewing an image or provides different images perceived by left and right eyes through special glasses.

As the form of providing a 3D effect using hologram technology, a floating image method has recently been commercialized, so an image projected on a transparent or semi-transparent film overlaps with a background image, thereby providing a 3D effect through a difference in distance between a front reflection image and the background image.

As the floating image technology, a front fixed viewing method is common when the number of projected surfaces is one, but after the number of projected surfaces is set to three or four and the projected surfaces are formed in the form of a triangular or quadrangular pyramid, images to be viewed from three or four viewpoints, respectively, are provided to be reflected on each surface from a bottom surface, so images of the same scene may be displayed differently for each field of view viewed from each surface.

In this hologram projection apparatus, hologram images of original quality are displayed when irradiating lasers of angles and wavelength bands to a projection plate in a production stage, but in real life, there is a problem in that the quality of a hologram image deteriorates due to irradiation of light (LED, etc.) of other wavelength bands.

As related prior art, there is Korean Patent Publication No. 10-1848353 (Title of Invention: HOLOGRAM PROJECTING APPARATUS FOR SMART PHONE, Registration Date: 2018 Apr. 6.)

### DISCLOSURE

### Technical Problem

An embodiment of the present invention provides a hologram projection apparatus and method capable of preventing deterioration in quality of a hologram image by adjusting angles of each projection module through calculation of optimal projection angles of each projection module.

Problems to be solved by the present invention are not limited to the above-described problem(s). Other problems that are not described may be obviously understood by those skilled in the art from the following description.

### Technical Solution

According to an aspect, a hologram projection apparatus includes: a hologram image projector configured to project a hologram test image for testing a hologram image onto a projection plate through a plurality of projection modules projecting R, G, and B images, respectively; an optimal angle calculation configured to calculate optimal projection angles of each of the projection modules when quality of the hologram test image does not satisfy reference quality; and a projection module adjuster configured to adjust angles of each of the projection modules to the optimal projection angles.

The optimal angle calculator may calculate the optimal projection angles of each of the projection modules based on laser angle and wavelength information when generating hogel patterns for each color of the projection plate.

In a unit of the hogel pattern, color units of the unit may be formed in the same size, or the color units may be formed in different sizes, numbers, or shapes.

The optimal angle calculator may calculate the optimal projection angles of each of the projection modules further based on wavelength information of light sources of each of the projection modules.

The projection module adjuster may adjust position deviations for each image of each of the projection modules, and the hologram image projector may project a hologram image onto the projection plate when the quality of the hologram test image according to the angle adjustment and the position deviation adjustment for each projection module satisfies the reference quality.

The projection module adjuster may measure a distance between the hologram projection apparatus and the projection plate, calculate the position deviations for each image of each of the projection modules based on the measured distance and the angle information for each projection module, and adjust the position deviations for each image of each of the projection modules by adjusting heights of each projection module according to the calculated position deviation.

The hologram projection apparatus may further include: an image quality detector configured to detect the quality of the hologram test image in a vision manner, in which the projection module adjuster may adjust the angles of the light sources for each color of each of the projection modules differently by being linked with the image quality detector.

According to another aspect, a hologram projection method using a hologram projection apparatus includes: projecting, by the hologram projection apparatus, a hologram test image for testing a hologram image onto a projection plate through a plurality of projection modules projecting R, G, and B images, respectively; calculating, by the hologram projection apparatus, optimal projection angles of each of the projection modules when quality of the hologram test image does not satisfy reference quality; and adjusting, by the hologram projection apparatus, angles of each of the projection modules to the optimal projection angles.

The hologram projection method may further include: adjusting, by the hologram projection apparatus, positional deviations for each image of each of the projection modules; detecting, by the hologram projection apparatus, the quality of the hologram test image according to angle adjustment and position deviation adjustment for each of the projection modules in a vision manner; and projecting, by the hologram projection apparatus, a hologram image onto the projection plate when the detected quality satisfies the reference quality.

The calculating of the optimal projection angle may include at least one of: calculating optimal projection angles of each of the projection modules based on laser angle and wavelength information when generating hogel patterns for each color of the projection plate; and calculating optimal projection angles of each of the projection modules based on wavelength information of light sources of each of the projection modules.

Detailed contents of other embodiments are described in a detailed description and are illustrated in the accompanying drawings.

### Advantageous Effects

According to an embodiment of the present invention, it is possible to prevent deterioration in quality of a hologram image by adjusting angles of each projection module through calculation of optimal projection angles of each projection module.

According to an embodiment of the present invention, position deviations for each projection module may be adjusted by calculating position deviations for each image and adjusting heights of each projection module, thereby preventing the deterioration in quality of the hologram image.

According to an embodiment of the present invention, by detecting the quality of a hologram test image in a vision manner and adjusting angles of light sources for each color of each projection module differently in conjunction with the detection, it is possible to prevent the quality of a hologram image from deteriorating.

### DESCRIPTION OF DRAWINGS

FIG. 1 is a block diagram illustrating a hologram projection apparatus according to an embodiment of the present invention.

FIG. 2 is a conceptual diagram for describing a principle of the hologram projection apparatus according to the embodiment of the present invention.

FIG. 3 is a diagram illustrating a process of adjusting a position deviation for an image by the hologram projection apparatus according to the embodiment of the present invention.

FIG. 4 is an overall flowchart illustrating a hologram projection method according to an embodiment of the present invention.

FIG. 5 is a flowchart illustrating a method of adjusting position deviations for each image according to an embodiment of the present invention.

### BEST MODE

Advantages and features of the present invention and methods accomplishing them will become apparent from the following description of embodiments with reference to the accompanying drawings. However, the present invention is not limited to exemplary embodiments to be described below, but may be implemented in various different forms, these embodiments will be provided only in order to make the present invention complete and allow those skilled in the art to completely recognize the scope of the present invention, and the present invention will be defined by the scope of the claims. Throughout the specification, like reference numerals denote like elements.

In addition, preferred embodiments of the present invention to be carried out below are provided in each system functional configuration in order to efficiently describe the technical components constituting the present invention, or system functional configurations commonly provided in the technical field to which the present invention pertains will be omitted as much as possible, and functional configurations that should be additionally provided for the present invention will be mainly described. If one has ordinary knowledge in the technical field to which the present invention belongs, one can easily understand the functions of conventionally used components among functional configurations not shown and omitted below. In addition, the relationship between the components omitted as described above and the components added for the present invention will also be clearly understood.

In addition, in the following description, “transmission”, “communication”, “transmitting”, “receiving”, and other similar terms of signals or information include transmission of signals or information from one component to another component, but also transmission via other components. In particular, “transmission” or “transmitting” of signals or information to a component indicates the final destination of the signals or information and does not mean a direct destination. The same is true for “reception” of the signals or information.

Prior to describing the embodiments of the present invention, principles of recording and restoring holograms will be briefly described. The principle of hologram recording and restoration will be explained based on a formation of an interference pattern of a reference beam and an object beam using a coherence laser. The hologram recording and restoration are determined by a laser wavelength λ and an angle (θ) between two beams (theoretical description in case a medium is very thin). When the recording medium is relatively thick, it may be described by the following theory.

A cycle λ of the pattern is determined by the laser wavelength λ and the angle θ between the two beams as shown in Equation 1 below.

$$Λ = \frac{λ}{2 sin ( \frac{θ}{2} )} \qquad [ Equation 1 ]$$

Here, the pattern refers to a periodic grating pattern engraved due to an interference phenomenon between the two beams, which is often referred to as a grating. In the hologram recording process, it is called hogel as a hologram pattern that contains information on a 3-dimensional space.

Regarding the hologram restoration, when a reference beam is reflected in a direction parallel to the grating, Equation 3 below is derived according to a Bragg condition of Equation 2 below.

$$sin ϕ = λ / 2 ∧ \qquad [ Equation 2 ]$$

$$sin ( \frac{θ}{2} ) = \frac{λ}{2 Λ} \qquad [ Equation 3 ]$$

Therefore, it can be seen that the angle θ and the wavelength λ of the laser are important parameters when implementing the restoration of the hologram recording. In this embodiment, the angle and wavelength information of the laser may be used to prevent the quality of the hologram image from deteriorating when restoring the hologram recording.

Meanwhile, specifications of a diode-pumped solid state laser used for the hologram recording in this embodiment are as follows for each module.

In the case of a blue laser, the wavelength is 457 nm±0.3 nm, and a spectral linewidth (FWHM) is 1 nm or less.

In the case of a red laser, the wavelength is 639.6 nm±0.2 nm, and the spectral linewidth (FWHM) is 1 nm or less.

In the case of a green laser, the wavelength is 532.2 nm±0.2 nm, and the spectral linewidth (FWHM) is 1 nm or less.

In this embodiment, specifications of a laser diode used for the hologram restoration (reproduction or implementation) are as follows for each module.

In the case of the blue laser, a minimum/maximum value (min. to max.) of the wavelength is 440 nm, 450 nm, 455 nm, 460 nm, etc., a wavelength deviation occurs depending on the temperature, and a wavelength varies depending on manufacturers. The spectral linewidth (FWHM) is 3 nm (data sheet) or less and 10 nm (experimental value) or less.

In the case of the red laser, the minimum/maximum value (min. to max.) of the wavelength is 630 nm, 633 nm, 636 nm, 638 nm, 644 nm, 645 nm, 650 nm, 660 nm, etc., the wavelength deviation occurs depending on the temperature, and the wavelength varies depending on manufacturers. The spectral linewidth (FWHM) is 2 nm (data sheet) or less and 10 nm (experimental value) or less.

In the case of the green laser, a minimum/maximum value (min. to max.) of the wavelength is 510 nm, 520 nm, 525 nm, 535 nm, etc., the wavelength deviation occurs depending on the temperature, and the wavelength varies depending on manufacturers. The spectral linewidth (FWHM) is 3 nm (data sheet) or less and 10 nm (experimental value) or less.

Hereinafter, embodiments of the present invention will be described in detail with reference to the accompanying drawings.

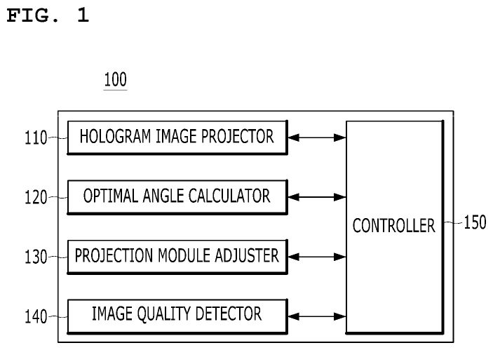

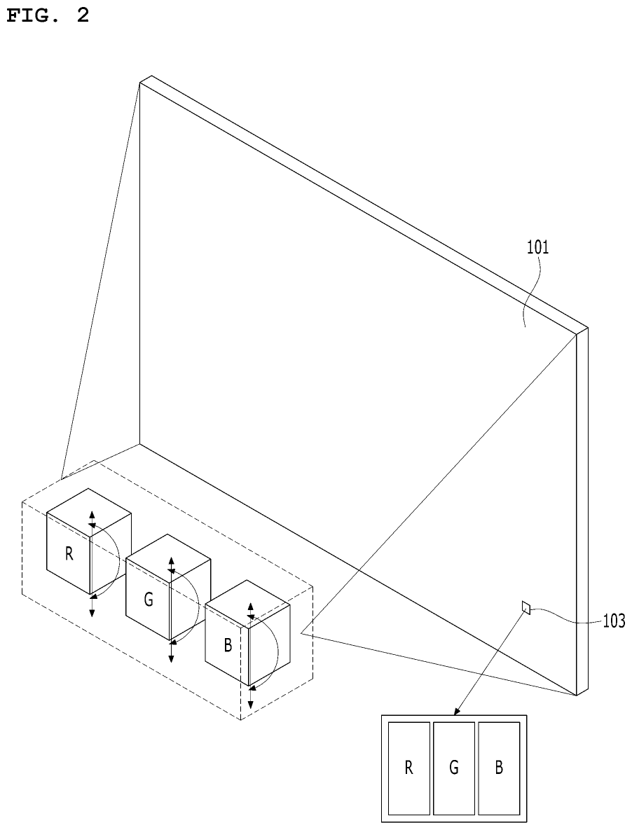

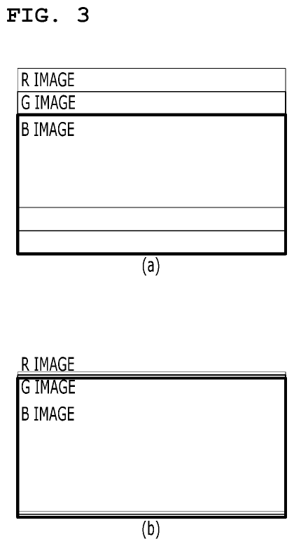

FIG. 1 is a block diagram illustrating a hologram projection apparatus according to an embodiment of the present invention, and FIG. 2 is a conceptual diagram for describing a principle of the hologram projection apparatus according to the embodiment of the present invention. FIG. 3 is a diagram illustrating a process of adjusting a position deviation for an image by the hologram projection apparatus according to the embodiment of the present invention.

Referring to FIGS. 1 to 3, a hologram projection apparatus 100 according to an embodiment of the present invention may be configured to include a hologram image projector 110, an optimal angle calculator 120, a projection module adjuster 130, and an image quality detector 140, and a controller 150.

The hologram image projector 110 may project a hologram test image for testing a hologram image onto a projection plate 101 through a plurality of projection modules 102 projecting R, G, and B images, respectively. Here, the plurality of projection modules 102 may be implemented as, for example, RGB laser modules, but are not limited thereto and may be implemented as various other modules, such as RGB LED modules.

The optimal angle calculator 120 may compare the quality of the hologram test image with a preset reference quality, and determine whether the quality of the hologram test image satisfies the reference quality according to the comparison result.

As a result of the determination, when the quality of the hologram test image does not satisfy the reference quality, the optimal angle calculator 120 may calculate an optimal projection angle of each of the projection modules 102.

To this end, as an embodiment, the optimal angle calculator 120 may calculate optimal projection angles of each of the projection modules 102 based on laser angle and wavelength information when generating hogel patterns for each color of the projection plate 101.

Here, in a unit 103 of the hogel pattern, color units of the unit 103 may be formed in the same size. Alternatively, the unit 103 of the hogel pattern, the color units of the unit 103 may be formed in different sizes, numbers, or shapes.

As another example, the optimal angle calculator 120 may calculate optimal projection angles of each of the projection modules 102 based on wavelength information of light sources of each of the projection modules 102.

As another embodiment, the optimal angle calculator 120 may calculate the optimal projection angles of each of the projection modules 102 based on the wavelength information of the light sources of each of the projection modules 102 as well as the laser angle and wavelength information when generating hogel patterns for each color of the projection plate 101.

The projection module adjuster 130 can adjust the angles of each of the projection modules 102 to the optimal projection angles (see angle adjustment in FIG. 2). Also, the projection module adjuster 130 may adjust position deviations for each image of the projection module 102 (see height adjustment in FIG. 2).

To this end, the projection module adjuster 130 may measure a distance between the hologram projection apparatus 100 and the projection plate 101. The projection module adjuster 130 may calculate the position deviations for each image of each of the projection modules 102 based on the measured distance and angle information for each projection module 102.

The projection module adjuster 130 may adjust heights of each projection module 102 according to the calculated position deviation to adjust the position deviations for each image of each of the projection modules 102 from FIG. 3A to FIG. 3B, as illustrated in FIG. 3.

That is, as illustrated in FIG. 3A, FIG. 3, where the position deviations for each image of each of the projection modules 102 are present, is a diagram illustrating a process of adjusting the position deviation for the image by the hologram projection apparatus according to an embodiment of the present invention.

In this case, the projection module adjuster 130 may adjust the heights of each projection module 102 to adjust the position deviations for each image of each of the projection modules 102 as illustrated in FIG. 3B.

When the angle adjustment and the position deviation adjustment for each projection module 102 are completed, the projection module adjuster 130 compares the quality of the hologram test image according to the angle adjustment and the position deviation adjustment for each projection module with the reference quality, and according to the comparison result, it is possible to determine whether the quality of the hologram test image satisfies the reference quality.

As a result of the determination, when the quality of the hologram test image satisfies the reference quality, the hologram image projector 110 may project the hologram image onto the projection plate 101. Here, the hologram image refers to a main hologram image originally to be projected onto the projection plate 101, not a test image.

The image quality detector 140 may perform a function of detecting the quality of the hologram test image in a vision manner. To this end, the image quality detector 140 may be implemented as a camera.

Accordingly, the projection module adjuster 130 may differently adjust angles of the light sources for each color of the projection module 102 by being linked with the image quality detector 140.

The image quality detector 140 may detect the quality of the hologram test image in the vision manner before the optimal angle calculator 120 compares the quality of the hologram test image with a reference quality.

In addition, the image quality detector 140 may detect the quality of the hologram test image in the vision manner before the projection module adjuster 130 compares the quality of the hologram test image with the reference quality.

That is, the image quality detector 140 may detect the quality of the hologram test image in the vision manner after the angle adjustment for each projection module 102 and the position deviation adjustment for each image (R, G, and B) are completed.

The controller 150 may control the overall operation of the hologram projection apparatus 100 according to an embodiment of the present invention, that is, the hologram image projector 110, the optimal angle calculator 120, the projection module adjuster 130, the image quality detector 140, and the like. The controller 250 may be implemented by including some or all functional components such as the hologram image projector 110, the optimal angle calculator 120, the projection module adjuster 130, and the image quality detector 140. That is, the controller 150 may perform some of the functions of the components, or may perform all of the functions of the components.

The controller 150 controls the overall operation of the hologram projection apparatus 100, and may include a processor such as a CPU. The controller 150 may control other components included in the hologram projection apparatus 100 to perform an operation corresponding to a user input received through the input/output unit. Here, the processor may process instructions within the computing device, and examples of these instructions may include instructions stored in a memory or a storage device to display graphic information for providing a graphic user interface (GUI) on an external input/output device, such as a display connected to a high-speed interface, for example. As another example, multiple processors and/or multiple buses may be used along with multiple memories and memory types as appropriate. Also, the processor may be implemented as a chipset composed of chips including a plurality of independent analog and/or digital processors.

The apparatus described above may be implemented as a hardware component, a software component, and/or a combination of the hardware component and the software component. For example, the devices and the components described in the embodiments may be implemented using one or more general purpose computers or special purpose computers such as a processor, a controller, an arithmetic logic unit (AUL), a digital signal processor, a microcomputer, a field programmable gate array (FPGA), a programmable logic unit (PLU), a microprocessor, or any other devices that may execute instructions and respond to the instructions. A processing device may execute an operating system (OS) and one or more software applications executed on the operating system. In addition, the processing device may access, store, manipulate, process, and create data in response to execution of software. Although a case in which one processing device is used is described for convenience of understanding, it may be recognized by those skilled in the art that the process device may include a plurality of processing elements and/or plural types of processing elements. For example, the processing device may include a plurality of processors or one processor and one controller. In addition, other processing configurations such as parallel processors are also possible.

The software may include computer programs, codes, instructions, or a combination of one or more thereof, and may configure the processing device to be operated as desired or independently or collectively command the processing device to be operated as desired. The software and/or the data may be permanently or temporarily embodied in any type of machine, component, physical device, virtual equipment, computer storage medium or device, or transmitted signal wave to be interpreted by the processing device or provide instructions or data to the processing device. The software may be distributed on computer systems connected to each other by a network to be thus stored or executed by a distributed method. The software and the data may be stored in one or more computer-readable recording media.

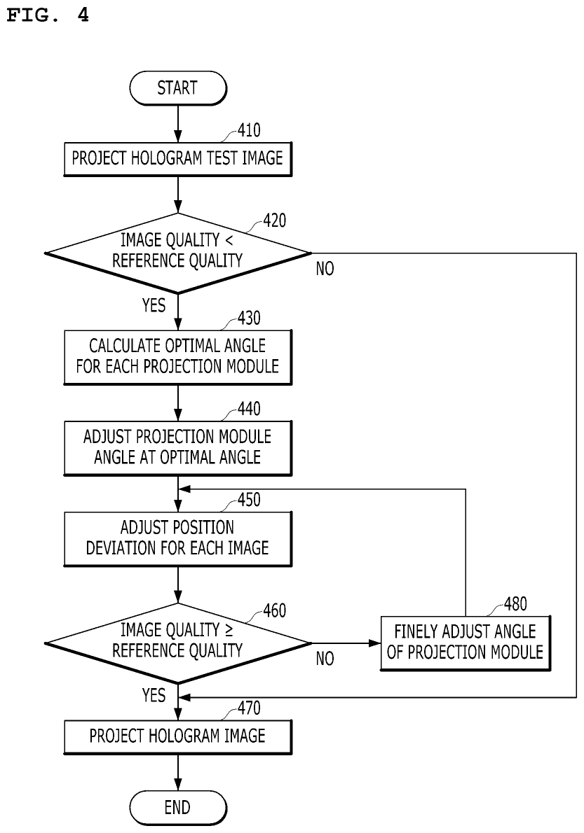

FIG. 4 is an overall flowchart illustrating a hologram projection method according to an embodiment of the present invention.

The hologram projection method described here may be performed by the hologram projection apparatus 100 of FIG. 1. In addition, since various steps may be added as follows, if necessary, and the following steps may also be performed in a changed order, the present invention is not limited to each step and their order described below.

First, referring to FIGS. 1 and 4, in step 410, the hologram projection apparatus 100 may project hologram test images for testing hologram images onto the projection plate 101 through a plurality of projection modules 102 that project R, G, and B images, respectively.

Next, in step 420, when the quality of the hologram test image does not satisfy the standard quality (yes direction in 420), in step 430, the hologram projection apparatus 100 may calculate the optimal projection angles for each projection module 102.

On the other hand, in step 420, when the quality of the hologram test image satisfies the reference quality (no direction in 420), the hologram projection apparatus 100 may move to step 470 to project the hologram image.

Next, in step 440, the hologram projection apparatus 100 may adjust angles of each of the projection modules 102 to the optimal projection angle.

Next, in step 450, the hologram projection apparatus 100 may adjust the position deviations for each image of each of the projection modules 102.

Next, in step 460, when the quality of the hologram test image according to the angle adjustment and the position deviation adjustment for each projection module 102 satisfies the reference quality (yes direction in 460), in step 470, the hologram projection apparatus 100 may project the hologram image onto the projection plate 101.

On the other hand, in step 460, when the quality of the hologram test image according to the angle adjustment and the position deviation adjustment for each projection module 102 satisfies the reference quality (no direction in 460), in step 480, the hologram projection apparatus 100 may finely adjust the angles of each projection module 102. Thereafter, the hologram projection apparatus 100 may perform step 450 again. This process may be repeated until the quality of the hologram test image satisfies the reference quality.

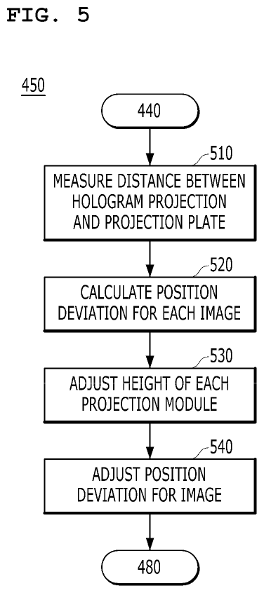

FIG. 5 is a flowchart illustrating a method of adjusting position deviations for each image according to an embodiment of the present invention.

Referring to FIGS. 1 and 5, in step 510, the hologram projection apparatus 100 may measure a distance between the hologram projection apparatus 100 and the projection plate 101.

Next, in step 520, the hologram projection apparatus 100 may calculate the position deviations for each image of the projection module 102 based on the measured distance and the angle information for each projection module 102.

Next, in step 530, the hologram projection apparatus 100 may adjust the heights of each projection module 102 according to the calculated position deviation.

Accordingly, in step 540, the hologram projection apparatus 100 may adjust the position deviations for each image of each of the projection modules 102 (see FIG. 3).

The methods according to the embodiment may be implemented in a form of program commands that may be executed through various computer means and may be recorded in a computer-readable recording medium. The computer-readable recording medium may include a program instruction, a data file, a data structure, or the like, alone or a combination thereof. The program commands recorded in the computer-readable recording medium may be especially designed and configured for the embodiments or be known to those skilled in a field of computer software. Examples of the computer-readable recording medium may include a magnetic medium such as a hard disk, a floppy disk, or a magnetic tape; an optical medium such as a compact disk read only memory (CDROM) or a digital versatile disk (DVD); a magneto-optical medium such as a floptical disk; and a hardware device specially configured to store and execute program commands, such as a ROM, a random access memory (RAM), a flash memory, or the like. Examples of the program commands include a high-level language code capable of being executed by a computer using an interpreter, or the like, as well as a machine language code made by a compiler. The abovementioned hardware device may be constituted to be operated as one or more software modules to perform the operations of the embodiments, and vice versa.

As described above, although the embodiments have been described by the limited embodiments and drawings, various modifications and alternations are possible by those of ordinary skill in the art from the above description. For example, even though the described techniques may be performed in a different order than the described method, and/or components of the described systems, structures, devices, circuits, etc., may be combined or combined in a different manner than the described method, or replaced or substituted by other components, appropriate results may be achieved.

Therefore, other implementations, other embodiments, and equivalents of the claims are within the scope of the following claims.

### MODE FOR INVENTION

Modes for carrying out the invention have been described together in the best mode for carrying out the invention above.

### INDUSTRIAL APPLICABILITY

The present invention relates to a hologram projection apparatus and method, and has repeatability and industrial applicability.

1. A hologram projection apparatus, comprising:
a hologram image projector configured to project a hologram test image for testing a hologram image onto a projection plate through a plurality of projection modules projecting R, G, and B images, respectively;
an optimal angle calculation configured to calculate optimal projection angles of each of the projection modules when quality of the hologram test image does not satisfy reference quality; and
a projection module adjuster configured to adjust angles of each of the projection modules to the optimal projection angles.

2. The hologram projection apparatus of claim 1, wherein the optimal angle calculator calculates the optimal projection angles of each of the projection modules based on laser angle and wavelength information when generating hogel patterns for each color of the projection plate.

3. The hologram projection apparatus of claim 2, wherein in a unit of the hogel pattern, color units of the unit are formed in the same size, or the color units are formed in different sizes, numbers, or shapes.

4. The hologram projection apparatus of claim 2, wherein the optimal angle calculator calculates the optimal projection angles of each of the projection modules further based on wavelength information of light sources of each of the projection modules.

5. The hologram projection apparatus of claim 1, wherein the projection module adjuster adjusts position deviations for each image of each of the projection modules, and
the hologram image projector projects a hologram image onto the projection plate when the quality of the hologram test image according to the angle adjustment and the position deviation adjustment for each projection module satisfies the reference quality.

6. The hologram projection apparatus of claim 5, wherein the projection module adjuster measures a distance between the hologram projection apparatus and the projection plate, calculates the position deviations for each image of each of the projection modules based on the measured distance and the angle information for each projection module, and adjusts the position deviations for each image of each of the projection modules by adjusting heights of each projection module according to the calculated position deviation.

7. The hologram projection apparatus of claim 1, further comprising:
an image quality detector configured to detect the quality of the hologram test image in a vision manner
wherein the projection module adjuster adjusts the angles of the light sources for each color of each of the projection modules differently by being linked with the image quality detector.

8. A hologram projection method using a hologram projection apparatus, comprising:
projecting, by the hologram projection apparatus, a hologram test image for testing a hologram image onto a projection plate through a plurality of projection modules projecting R, G, and B images, respectively;
calculating, by the hologram projection apparatus, optimal projection angles of each of the projection modules when quality of the hologram test image does not satisfy reference quality; and
adjusting, by the hologram projection apparatus, angles of each of the projection modules to the optimal projection angles.

9. The hologram projection method of claim 8, further comprising:
adjusting, by the hologram projection apparatus, positional deviations for each image of each of the projection modules;
detecting, by the hologram projection apparatus, the quality of the hologram test image according to angle adjustment and position deviation adjustment for each of the projection modules in a vision manner; and
projecting, by the hologram projection apparatus, a hologram image onto the projection plate when the detected quality satisfies the reference quality.

10. The hologram projection method of claim 8, wherein the calculating of the optimal projection angle includes at least one of:
calculating optimal projection angles of each of the projection modules based on laser angle and wavelength information when generating hogel patterns for each color of the projection plate; and
calculating optimal projection angles of each of the projection modules based on wavelength information of light sources of each of the projection modules.
